(19) United States
(12) Patent Application Publication
(10) Pub. No.: US 2022/0167762 A1
(43) Pub. Date: Jun. 2, 2022

(54) ROCKING PHOTO DISPLAY ASSEMBLY

(71) Applicant: Umbra LLC, Buffalo, NY (US)

(72) Inventor: Sung Wook Park, Toronto (CA)

(21) Appl. No.: 17/107,180

(22) Filed: Nov. 30, 2020

(51) Int. Cl. A47G 1/14; F16M 11/20

(52) U.S. Cl. CPC A47G 1/142; F16M 2200/044; F16M 11/2014

(57) ABSTRACT

A photo display assembly, comprising, a base having a support post extending upwardly therefrom, said support post having an upper end and a lower end, the upper end of the support post having a concave depression therein, the second end fixedly secured to the base, a frame housing having four substantially transparent walls, each wall arranged substantially perpendicular to each adjacent wall, a support cage having a central spindle and a plurality of arms extending downwardly from the spindle, the arms arranged to secure to and support the walls, and the spindle arranged to rest in the concave depression, support the housing, and also arranged for rotation about the support post.

### FIELD

The present invention relates generally to photo displays and, more particularly, to a photo display arranged to display multiple photos.

### BACKGROUND

Frames and displays for photos and other works of art are well-known. Some frames and displays are designed for desktop use, others for wall mounting. Some displays are arranged to display a single photo or work of art; others are arranged to display multiple works of art. Many devices display photos in a single plane, while others display in multiple planes (e.g., cubes). Many of these devices are “static” and “non-moving” while some are arranged for rotation, etc. Designers are constantly seeking new ways to display photos and other works of art in novel and aesthetically pleasing ways.

What has been needed is a display for multiple photos or other works of art arranged in a housing which is configured for both rotation about a pedestal and for rocking atop that pedestal.

### SUMMARY

The present invention broadly comprises a photo display assembly, comprising a base having a support post extending upwardly therefrom, said support post having an upper end and a lower end, said upper end of said support post having a concave depression therein, said second end fixedly secured to said base, a frame housing having four substantially transparent walls, each wall arranged substantially perpendicular to each adjacent wall, a support cage having a central spindle and a plurality of arms extending downwardly from said spindle, said arms arranged to secure to and support said walls, and said spindle arranged to rest in said concave depression, support said housing, and also arranged for rotation about said support post.

A general object to this invention is to provide a display for multiple photos or other works of art arranged in a housing which is configured for both rotation about a pedestal and for rocking atop that pedestal.

This and other objects, features, and advantages of the present disclosure will become readily apparent upon a review of the following detailed description of the disclosure, in view of the drawings and appended claims.

### BRIEF DESCRIPTION OF THE DRAWINGS

Various embodiments are disclosed, by way of example only, with reference to the accompanying schematic drawings in which corresponding reference symbols indicate corresponding parts, in which:

FIG. 1 is a front perspective view of the present invention;

FIG. 2 is a front side view of the present invention in FIG. 1;

FIG. 3 is a side view of the present invention rotated counterclockwise with respect to FIG. 2;

FIG. 4 is a side view of the present invention rotated counterclockwise with respect to FIG. 3;

FIG. 5 is a side view of the present invention rotated counterclockwise with respect to FIG. 4;

FIG. 6 is a front side view of the present invention showing hidden lines that depict side to side movement of the present invention in FIG. 1;

FIG. 7 is a front side view of the present invention showing hidden lines that depict side to side movement of the present invention in FIG. 1;

FIG. 8A is an iso metric view of the frame housing of the present invention shown in FIG. 1;

FIG. 8B is a top view of the frame housing of the present invention shown in FIG. 1;

FIG. 9 is a front side view of the post and the support cage of the present invention shown in FIG. 1;

FIG. 10 is a sectional view of the post and the support cage taken generally along lines 10-10 in FIG. 9;

FIG. 11 is a left side exploded view of the present invention shown in FIG. 1; and,

FIG. 12 is a perspective exploded view of the present invention shown in FIG. 1.

### DETAILED DESCRIPTION

At the outset, it should be appreciated that like drawing numbers on different drawing views identify identical, or functionally similar, structural elements. It is to be understood that the claims are not limited to the disclosed aspects.

Furthermore, it is understood that this disclosure is not limited to the particular methodology, materials and modifications described and as such may, of course, vary. It is also understood that the terminology used herein is for the purpose of describing particular aspects only and is not intended to limit the scope of the claims.

Unless defined otherwise, all technical and scientific terms used herein have the same meaning as commonly understood to one of ordinary skill in the art to which this disclosure pertains. It should be understood that any methods, devices or materials similar or equivalent to those described herein can be used in the practice or testing of the example embodiments.

It should be appreciated that the term “substantially” is synonymous with terms such as “nearly,” “very nearly,” “about,” “approximately,” “around,” “bordering on,” “close to,” “essentially,” “in the neighborhood of,” “in the vicinity of,” etc., and such terms may be used interchangeably as appearing in the specification and claims. It should be appreciated that the term “proximate” is synonymous with terms such as “nearby,” “close,” “adjacent,” “neighboring,” “immediate,” “adjoining,” etc., and such terms may be used interchangeably as appearing in the specification and claims.

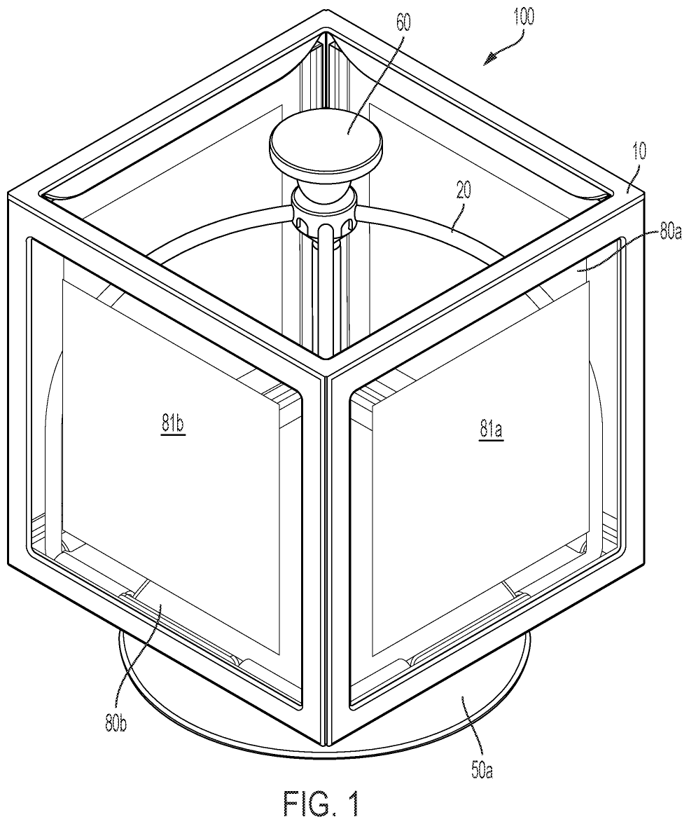

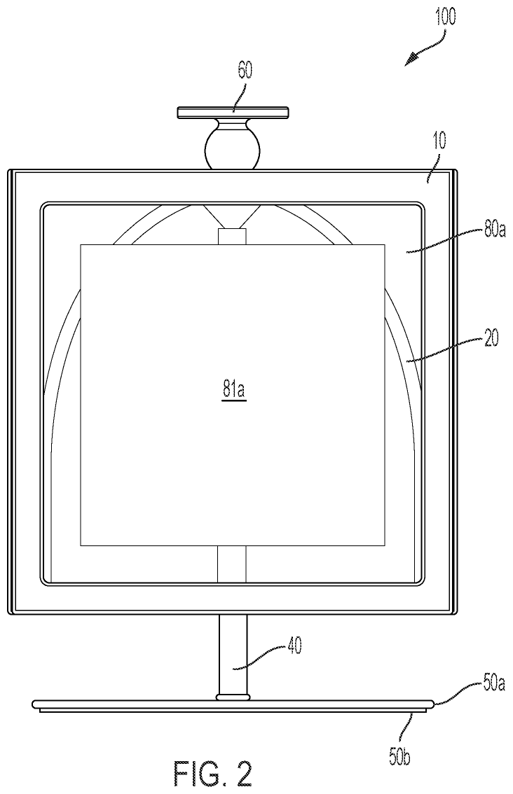

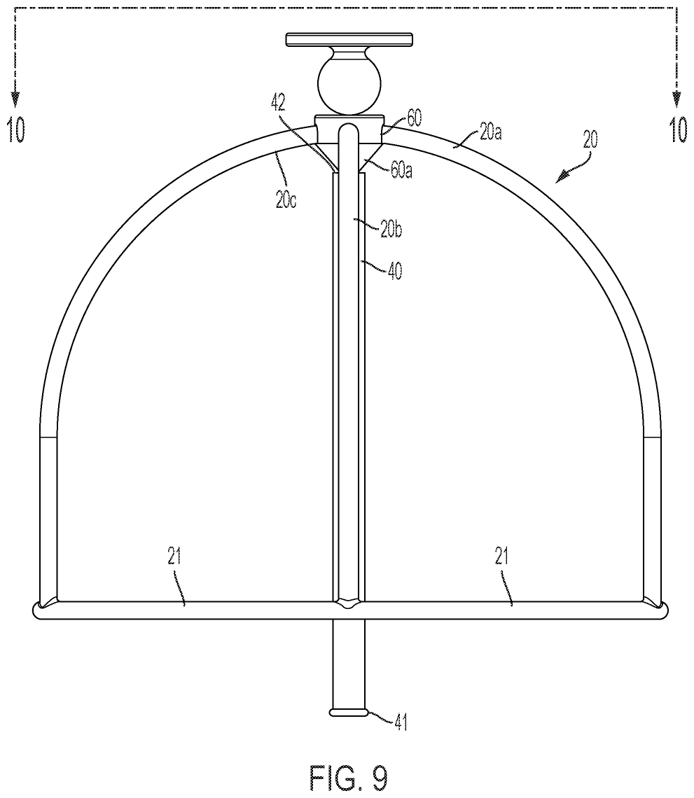

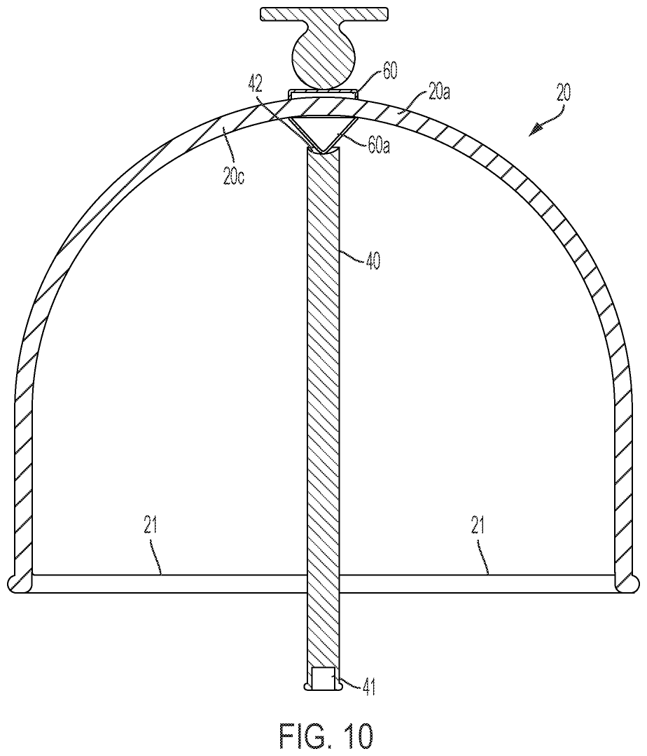

Adverting now to the figures, the following description should be taken in view of FIGS. 1-2. Photo display assembly 100 comprises, support housing 10, support cage 20, base 50a, spindle 60, first glass pane 80a, second glass pane 80b, first photo 81a, and second photo 81b. Base 50a is fixed to pad 50b on a bottom surface. Post 40 is fixedly secured to base 50a either threadably or by any other suitable attachment means. Post 40 is arranged to accept spindle 60 at its top end that is a substantially concave depression (FIGS. 9 and 10, discussed further infra). Spindle 60 is fixedly secured to support cage 20. Support housing 10 is arranged to engage support cage 20 and rest thereon. Support housing is arranged to hold a plurality of outer glass panes, photos, and inner glass panes. Shown in FIG. 1 is first outer glass pane 80a, first photo 81a, second outer glass pane 80b, and second photo 81a.

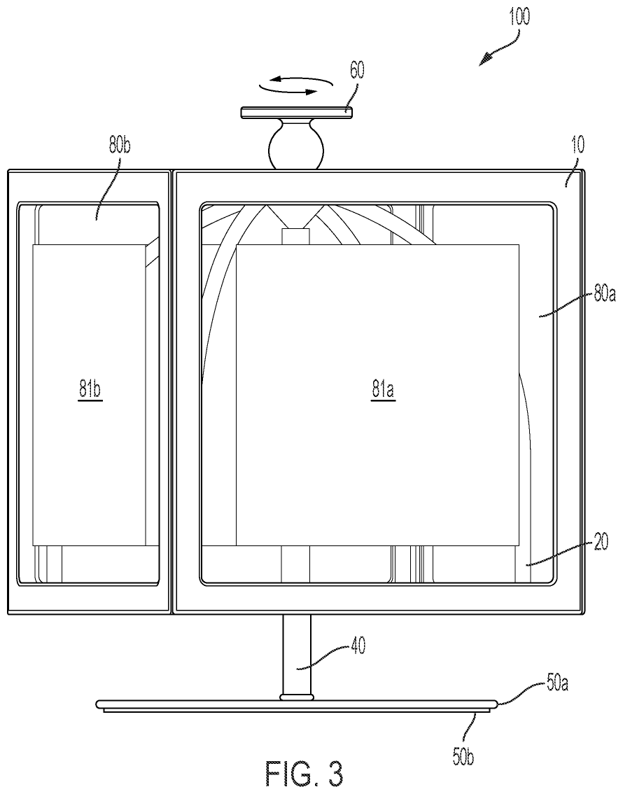

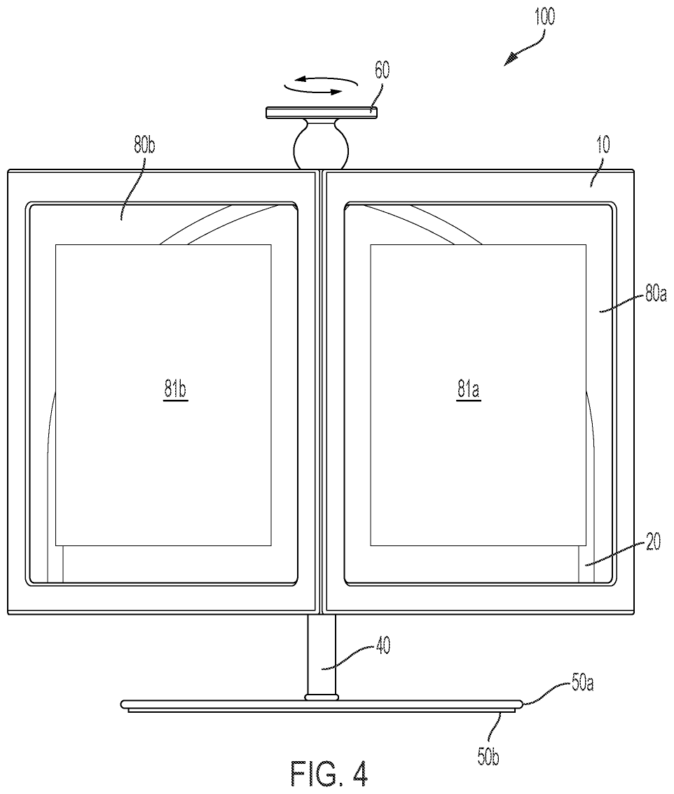

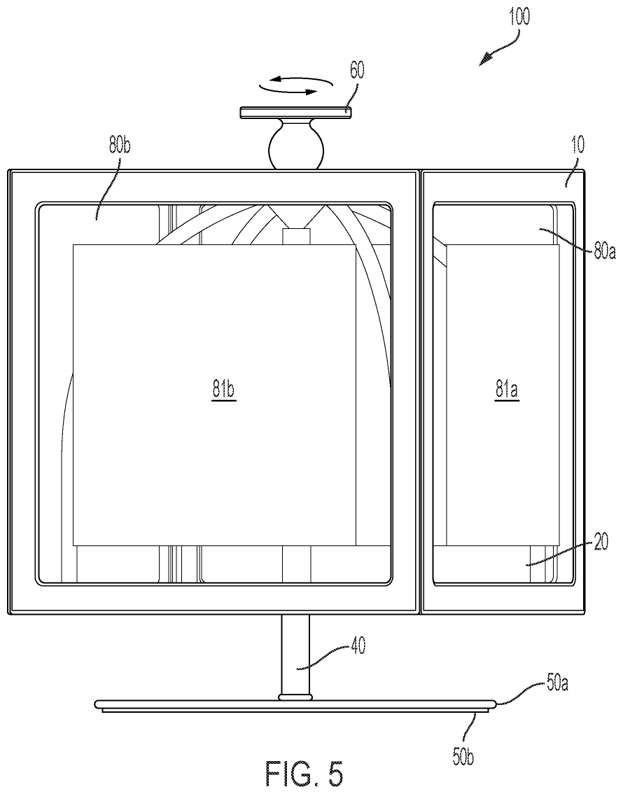

FIGS. 3-5 illustrate a side view of photo display assembly 100 being rotated counterclockwise about support post 40. It should be appreciated that assembly 100 may be rotated in either the clockwise or counterclockwise direction. Spindle 60 has tip 60a that is frustoconical in shape (shown in FIGS. 9-12) and is arranged to rest within concave depression 42 of support post 40 (shown in FIGS. 9 and 10, discussed further infra). Since support cage 20 is fixed to spindle 60 and support housing 10 is secured to support 20, all of the components of assembly 100, besides support post 40, base 50a, and pad 50b rotate together about support post 40 as shown in FIGS. 3-5.

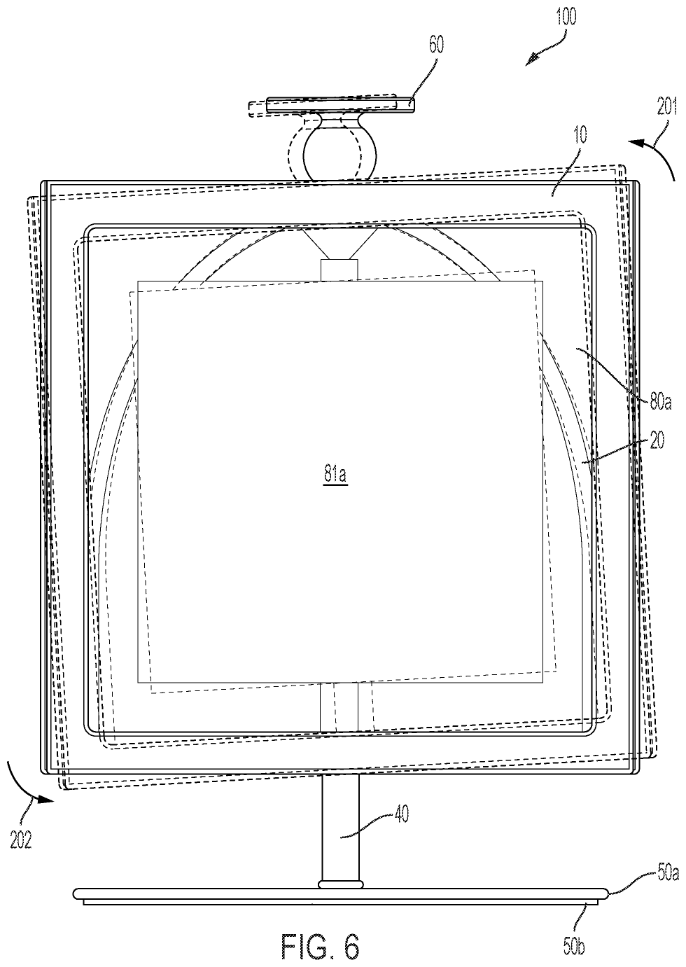

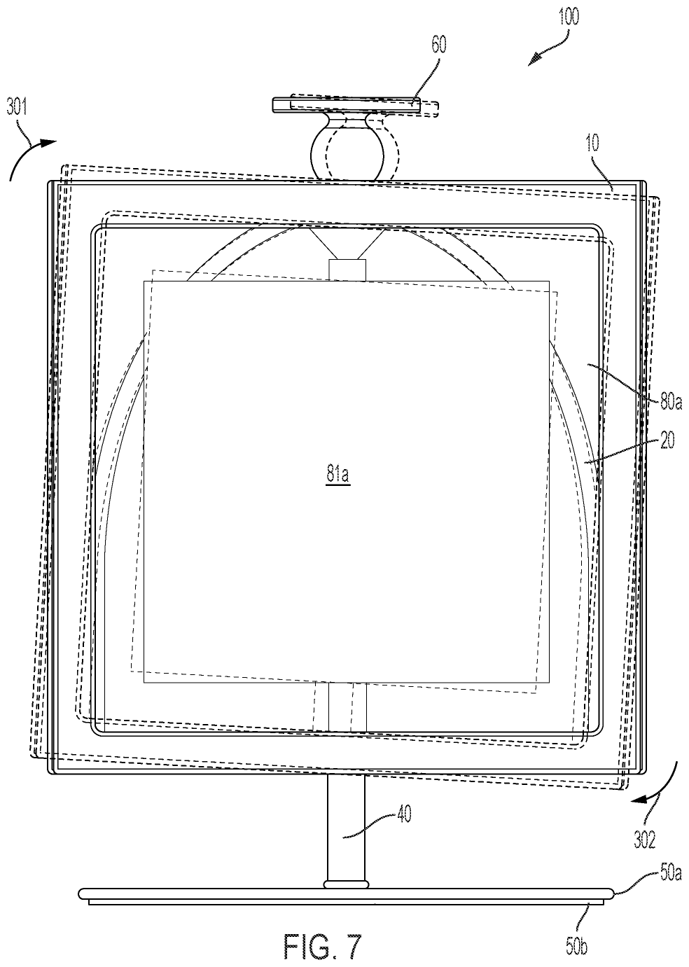

Adverting now to FIGS. 6 and 7, illustrating the rocking motion of photo display assembly 100. FIGS. 6 and 7 depict hidden lines that show rocking motion 201, 202, 301 and 302 of assembly 100. Rocking motion 201, 202, 301 and 302 are achieved in a similar fashion to the rotation described supra via tip 60a of spindle 60. Spindle 60 has tip 60a that is frustoconical in shape (shown in FIGS. 9-12 and discussed further infra) and is arranged to rest within concave depression 42 of support post 40 (shown in FIGS. 9 and 10, discussed further infra). Since support cage 20 is fixed to spindle 60 and support housing 10 is secured to support 20, all of the components of assembly 100, besides support post 40, base 50a, and pad 50b rock within the concave depression of support post 40 via bottom 60a of spindle 60, as shown in FIGS. 6 and 7.

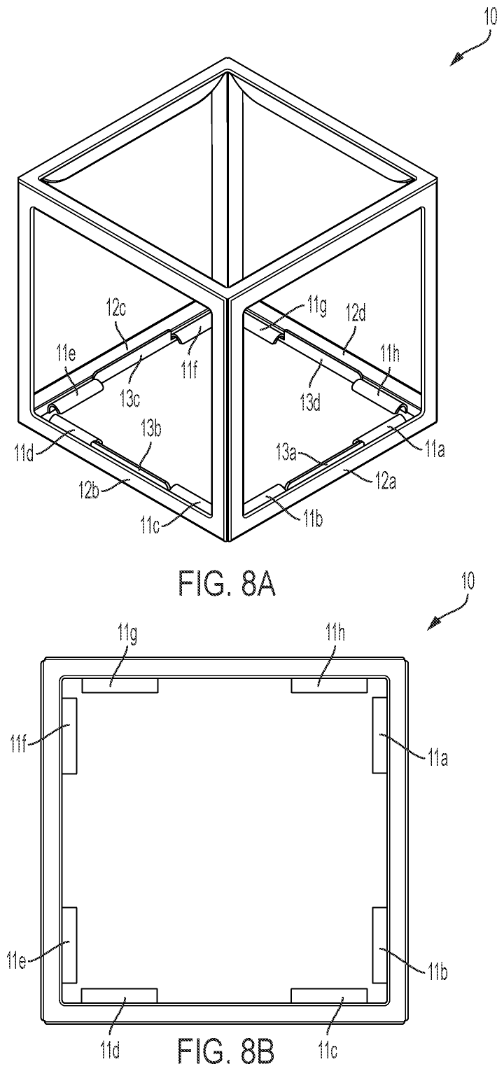

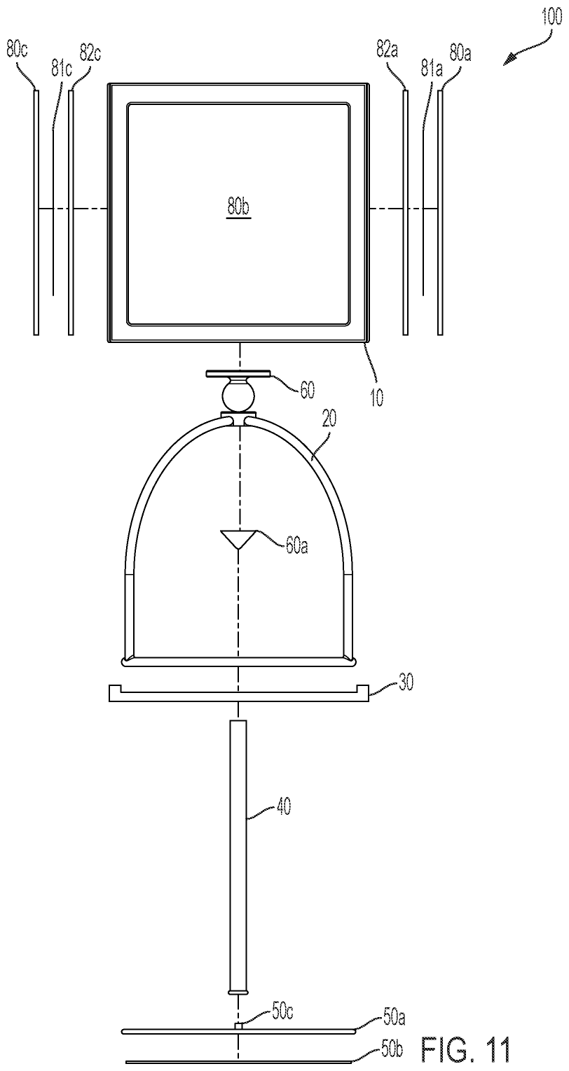

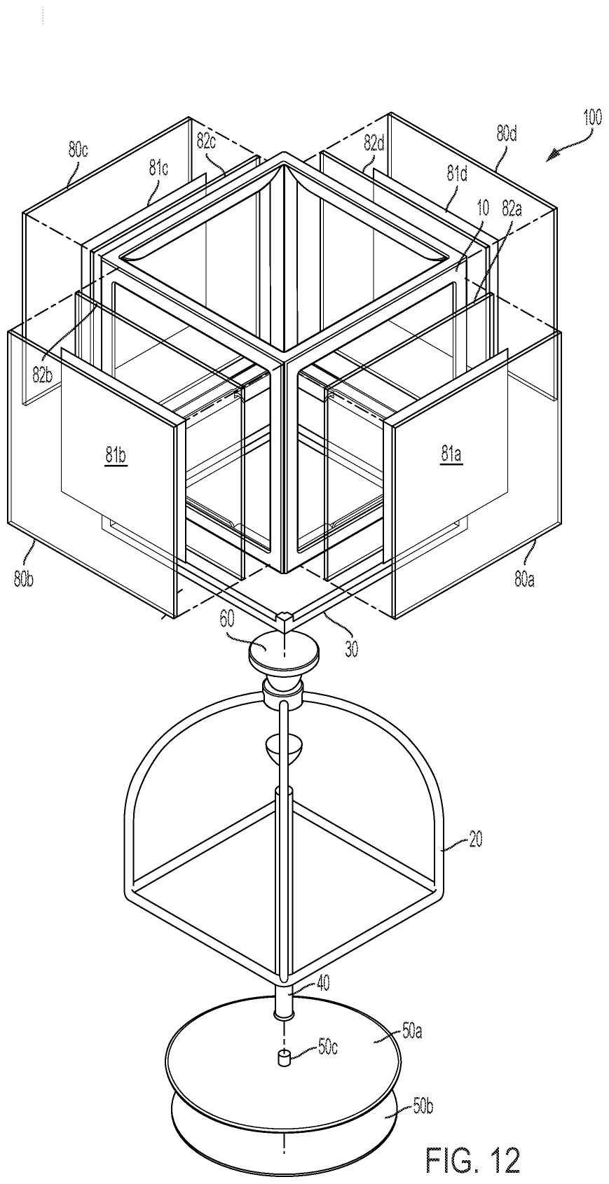

FIG. 8A illustrates support frame 10 of photo display assembly 100. Assembly 100 is arranged to accept four (4) outer glass panes, four (4) photos, and four (4) inner glass panes (Shown in FIGS. 11 and 12 and discussed further infra). Support frame 10 in a preferred embodiment, is cube shaped having equal edges or members. Frame 10 includes plurality of clips 11a-11g, that are arranged to rest on the bottom members of support cage 20. Each of bottom members 12a-12d of frame 10 have two clips arranged on their inside surface. Clips 11a-11g are all arranged to rest on the top surface of the bottom members of support cage 20. The clips may allow frame 10 to be easily removed from cage 20 for moving or adjusting the photos within support frame 10. It should be appreciated that clips 11a-11g may also be comprised of a flexible material such that they will frictionally grip the bottom members of support cage 20.

FIG. 8A also shows a plurality of glass pane braces that support the outer glass panes, photos, and inner glass panes when fully installed within frame 10. Inner glass pane braces 13a-13d are arranged on the center of bottom members 12a-12d, respectively.

FIG. 8B illustrates a top view of support frame 10 of assembly 100. Clips 11a-11g are shown fixedly secured to frame 10. Clips 11a-11g must be equally spaced on the bottom support members of frame 10. Equal spacing ensures a center of gravity that allows support cage 20 and spindle 60 to maintain a completely upright position within support post 40 (shown in FIGS. 1-5). Failure to properly space clips 11a-11g may result in a permanent tilt of support cage 20 and support 60 within support post 40 (similarly depicted by the hidden lines shown in FIGS. 6 and 7).

FIG. 9 illustrates support post 40, support cage 20, and spindle 60 of photo display assembly 100. Support post 40 has two ends, the bottom end having partial through-bore 41 arranged to engage base 50, and the top end having concave depression 42. Spindle 60 rotates about an axis of rotation and functions as the connection point of vertical support cage members 20a-20d. Vertical support cage members 20a-20d have distal ends that extend downwardly from spindle 60 and extend horizontally to form a continuous and substantially square-shaped support cage bottom member 21. Spindle 60 includes tip 60a that is either fixed or removably attached to spindle 60. Tip 60a is a conical shape having a point at its center. Tip 60a is arranged to rest in the center of concave depression 42 of support post 40 to maintain a completely upright position within support post 40 (shown in FIGS. 1-5). It should be appreciated that support cage 20, spindle 60 and support tip 60 may all be separate components, or may be a singular fixed piece, or may be a combination of fixed and separate components, and their arrangement only matters with respect to maintaining a perfectly centered contact of tip 60a and the midpoint of concave depression 41.

FIG. 10 illustrates a sectional view of support post 40, support cage 20, and spindle 60 of photo display assembly 100, taken generally along lines 10-10 in FIG. 9. It should be appreciated that FIG. 9 shows an embodiment of a fixed spindle 60 and support cage 20 with a removably secured tip 60a. The combination of separate or fixed configurations of spindle 60, support cage 20, and tip 60a must position tip 60a of spindle 60 within the midpoint of concave depression 42 of support post 40. Also shown in FIG. 9 is partial through-bore 41 of support post 40 that is arranged to engage protrusion 50c of base 50 (Shown in FIGS. 11 and 12). Partial through-bore 41 may also be threaded or have frictional tabs to engage protrusion 50c of base 50 more securely (Shown in FIGS. 11 and 12, and further discussed infra).

The following description should be taken in view of FIG. 11 and FIG. 12. FIG. 11 illustrates a left side exploded view of the present invention. FIG. 12 illustrates an exploded perspective view of the present invention. Beginning with the upper components of photo display assembly 100; support frame 10 is configured to accept outer glass panes 80a-80d, photos 81a-81d, and inner glass pane 82a-82d. The following configuration for securing photos in frame 10 applies to all of the abovementioned components. First, inner glass pane 80a is first inserted into the vertical space formed by the members of frame 10, then first photo 81a is inserted onto first inner glass pane 80a, lastly, first outer glass pane 82a is inserted into frame 10 sandwiching first photo 81a between first inner glass pane 80a and first outer glass pane 82a. The glass panes, 80a-80d and 82a-82d, may be secured via a snap-fit by inserting on edge diagonally into frame 10 then pressing the opposite edge into frame 10. Inner glass pane braces 13a-13d (shown in FIGS. 8A and 8B) assist in securing the glass panes within frame 10. It should be appreciated that other means of securing glass panes, 80a-80d and 82a-82d, may be used, such as glazier points or standard rotational tabs, commonly used within the art.

Adverting to the lower components of photo display assembly 100; tip 60a is engaged to spindle 60 and support cage 20, either threadably or by any other suitable means, such as a snap fit. Post 40 is then secured to base 50a via protrusion 50c, either threadably, or by any other suitable means, such as a snap fit. Base 50a also has pad 50b secured to its bottom surface. Pad 50b may be comprised of a non-slip or gripping material. Spindle 60 and support cage 20 are placed into concave depression 42 of post 40 (shown in FIGS. 9 and 10, discussed supra), engaging tip 60a with the midpoint of concave depression 42, as described supra. Once outer glass panes 80a-80d, photos 81a-81d, and inner glass pane 82a-82d are inserted into frame 10, frame 10 is placed onto support cage bottom member 21 (shown in FIGS. 9 and 10) via clips 11a-11g of frame 10 (shown in FIGS. 8A and 8B). The resulting configuration of assembly 100 has a center of gravity of frame 10 and cage 20 that is colinear with tip 60a of spindle 60 within concave depression 42 of post 40. It should be noted that, in a preferred embodiment, tip 60a is conical in shape. Specifically, as shown, tip 60a is in the shape of an inverted cone. This cone is defined by an upper base and a lower vertex point (tip of the cone) which is colinear with the center of its base, and also defines the aforementioned axis of rotation of the spindle and housing. The center of gravity of the housing is designed to be colinear with the axis of rotation, which results in the housing being able to both balance and rock atop the support post.

It should be appreciated that the embodiment as shown is only one of a variety of possible embodiments of the claimed invention. For example, although a preferred embodiment of a cube-shaped housing is depicted in the drawings and described in the specification, it should be apparent that other housing shapes are possible. For example, the housing could take the shape of a parallelopiped or other shape having a quadrilateral cross-section. Nor does the housing have to have a quadrilateral cross-section; it could have a trilateral cross-section (e.g., an equilateral triangular cross-section), or even hexagonal, octagonal, etc., as long as the housing is designed such that its center of gravity is colinear with the center of gravity of the axis of rotation of the spindle which supports the housing.

It will be appreciated that various aspects of the disclosure above and other features and functions, or alternatives thereof, may be desirably combined into many other different systems or applications. Various presently unforeseen or unanticipated alternatives, modifications, variations, or improvements therein may be subsequently made by those skilled in the art which are also intended to be encompassed by the following claims.

### REFERENCE NUMERALS

10 support housing
11a first clip of support housing 10
11b second clip of support housing 10
11c third clip of support housing 10
11d fourth clip of support housing 10
11e fifth clip of support housing 10
11f sixth clip of support housing 10
11g seventh clip of support housing 10
11h eighth clip of support housing 10
12a first bottom member of support housing 10
12b second bottom member of support housing 10
12c third bottom member of support housing 10
12d fourth bottom member of support housing 10
13a first inner glass pane brace
13b second inner glass pane brace
13c third inner glass pane brace
13d fourth inner glass pane brace
20 wire support cage
20a first wire of wire support cage 20
20b second wire of wire support cage 20
20c third wire of wire support cage 20
20d fourth wire of wire support cage 20
21 bottom rim of support cage 20
30 spacer
40 support post
41 threaded aperture of support post 40
50a bottom base
50b pad of bottom base 50a
50c protrusion of base 50a
60 spindle
60a tip of spindle 60
80a first outer glass pane
80b second outer glass pane
80c third outer glass pane
80d fourth outer glass pane
81a first photo
81b second photo
81c third photo
81d fourth photo
82a first inner glass pane
82b second inner glass pane
82c third inner glass pane
82d fourth inner glass pane
100 photo display assembly
201 rocking motion
202 rocking motion
301 rocking motion
302 rocking motion

What is claimed is:

1. A photo display assembly, comprising:
a base having a support post extending upwardly therefrom, said support post having an upper end and a lower end, said upper end of said support post having a concave depression therein, said second end fixedly secured to said base;
a frame housing having four substantially transparent walls, each wall arranged substantially perpendicular to each adjacent wall;
a support cage having a central spindle and a plurality of arms extending downwardly from said spindle, said arms arranged to secure to and support said walls, and said spindle arranged to rest in said concave depression, support said housing, and also arranged for rotation about an axis of rotation, wherein said axis of rotation is colinear with a longitudinal axis of said support post.

2. The photo display assembly recited in claim 1 wherein each of said walls comprises a glass pane bordered by a frame.

3. The photo display assembly recited in claim 1 wherein a center of gravity of said housing and cage assembly is colinear with an axis of rotation of said spindle.

4. The photo display assembly recited in claim 1 further comprising a pad fixedly secured to a bottom surface of said base.

5. The photo display assembly recited in claim 1 wherein said spindle has a substantially conically shaped tip arranged for rotation and rocking within said depression.

6. The photo display assembly recited in claim 1 wherein said frame further comprises a plurality of clips fixedly secured to a plurality of bottom members of said frame.

7. The photo display assembly recited in claim 6 wherein said clips are arranged to engage a lower end of each cage arm of said cage and rest thereon.

8. The photo display recited in claim 1 wherein said frame is arranged to accept four photos on said four substantially transparent walls, said frame is also arranged to accept an additional four substantially transparent walls relative to an outside surface of said four photos.

9. A photo display assembly, comprising:
a base having a support post extending upwardly therefrom, said support post having an upper end and a lower end, said upper end of said support post having a concave depression therein, said second end fixedly secured to said base;
a frame housing having a center of gravity;
a support cage having a central spindle and a plurality of arms extending downwardly from said spindle, said arms arranged to secure to and support said walls, and said spindle arranged to rest in said concave depression, support said housing, and also arranged for rotation about an axis of rotation, wherein said axis of rotation is colinear with a longitudinal axis of said support post, and wherein said center of gravity of said housing is colinear with said axis of rotation.
